(19) United States
(12) Patent Application Publication
(10) Pub. No.: US 2014/0195312 A1
(43) Pub. Date: Jul. 10, 2014

(54) SYSTEM AND METHOD FOR MANAGEMENT OF PROCESSING WORKERS

(71) Applicant: Locu, Inc., San Francisco, CA (US)

(72) Inventors: Jason Ansel, Cambridge, MA (US); Matthew Greenstein, San Francisco, CA (US); Daniel Haas, Berkley, CA (US); Kainar Kamalov, San Francisco, CA (US); Adam Marcus, Cambridge, MA (US); Marek Olszewski, San Francisco, CA (US); Marc Piette, San Francisco, CA (US); Rene Reinsberg, San Francisco, CA (US); Stylianos Sidiroglou, Cambridge, MA (US)

(73) Assignee: Locu, Inc., San Francisco, CA (US)

(21) Appl. No.: 14/209,306

(22) Filed: Mar. 13, 2014

Related U.S. Application Data
(63) Continuation-in-part of application No. 13/605,051, filed on Sep. 6, 2012.
(60) Provisional application No. 61/818,713, filed on May 2, 2013.

(51) Int. Cl. G06Q 10/06

(52) U.S. Cl. CPC G06Q 10/06398
USPC 705/7.42

(57) ABSTRACT

A system and method for automatically determining an amount of review a crowd-sourcing task needs after an initial review has been completed by a processing worker. An evaluation metric is automatically assigned to the work performed by the processing worker to determine the appropriate amount of human review required for a particular task. The evaluation metric may be calculated by accessing and evaluating a plurality of transaction categories related, but not limited to, worker characteristics, document characteristics and processing characteristics. Additionally, the evaluation metric may be used to determine compensation of the processing worker and whether a promotion or demotion is necessary. The system is also capable of balancing individual workloads based upon the evaluation metric.

### CROSS-REFERENCE TO RELATED APPLICATIONS

This application is a continuation-in-part of U.S. patent application Ser. No. 13/605,051 filed on Sep. 6, 2012 and entitled “METHOD AND APPARATUS FOR FORMING A STRUCTURED DOCUMENT FROM UNSTRUCTURED INFORMATION,” and this application claims the benefit of U.S. Provisional Patent Application Ser. No. 61/818,713 filed on May 2, 2013 and entitled “SYSTEMS AND METHODS FOR AUTOMATED DATA CLASSIFICATION, MANAGEMENT OF CROWD WORKER HIERARCHIES, AND OFFLINE CRAWLING.”

### STATEMENT REGARDING FEDERALLY SPONSORED RESEARCH

N/A

### BACKGROUND OF THE INVENTION

The present invention relates to systems and methods for evaluating worker quality. More particularly, the invention relates to systems and methods for automatically evaluating work performed by a processing worker using a plurality of transaction categories.

Recently, crowd-sourcing has emerged as an effective and efficient approach to analyzing data, enabled by platforms such as Amazon's Mechanical Turk. In crowd-sourcing, a large task is divided into smaller tasks. The smaller tasks are then distributed to a large pool of crowd workers, typically through a website or other online means. The crowd workers complete the smaller tasks for small payments, resulting in substantially lower overall costs. For example, the smaller tasks may include extracting semantic information from an image of a document, and possibly evaluating the accuracy of a machine classification and making corrections to features that were misclassified. Further, the crowd workers can work concurrently, thus speeding up the completion of the original large task. Despite the speed improvements and lower costs, crowd-sourcing is limited in several ways.

For example, individual crowd workers are often inaccurate and generally produce lower quality completed tasks. Requesting a greater, fixed number of tasks can improve overall accuracy, but in practice, many of these are not needed, resulting in wasted expense. Automatic machine classifiers are sometimes combined with crowd-sourcing to increase accuracy. However, current implementations are open to cheating by crowd workers, as the output from the automatic machine classifiers is given to the crowd workers as a suggested task, and the workers have an obvious incentive to make as few edits as possible, as they are paid by the task.

In addition, workers can naturally perform some tasks incorrectly, but there are often workers that incorrectly perform more than expected for their share of tasks. Some of the low-quality workers may not have the necessary abilities for the tasks, some may not have adequate training, and some may simply be “spammers” that want to make money without doing much work. Anecdotal evidence indicates that the spammer category is especially problematic, since these workers not only do poor work, but they do a large volume of the work as they try to maximize their income.

Other conventional crowdsourcing systems have implemented crowd worker hierarchies. Because no training is typically needed for the tasks, no training is needed for the verification of the work. However, numerous tasks may require an assisted learning phase that includes training by humans familiar with the desired outcome of the task. Thus, some crowdsourcing systems include human workers (i.e., entry level workers) and human verifiers. The human workers typically request a correction task and perform the task. The completed task is then reviewed and marked complete or incomplete by the human verifiers. If the task is marked incomplete by the human verifier, several rounds of back-and-forth review between the human verifier and human worker may occur. While this system helps solve the problem of managing worker quality, it is not economically efficient in that each task is reviewed by multiple reviewers and, therefore, high transaction costs per task are created. Additionally, workflow may be interrupted by having multiple reviewers reviewing each task, thereby creating a bottleneck scenario.

Thus, worker quality control is an important aspect of crowdsourcing systems; typically occupying a large fraction of the time and money invested on crowdsourcing. To correct or compensate for poor worker quality, a crowd-sourcing system can implement some type of worker quality control. Typically workers have known identities, so that worker quality control can identify the poor workers and then possibly take action against them or against their results. These and other challenges remain as significant obstacles to improving a wide range of technologies that rely on crowd-sourcing.

### SUMMARY OF THE INVENTION

The present invention overcomes the aforementioned drawbacks by providing a system and method for automatically analyzing a given work product from a variety of indications that may not be traditionally considered as a direct indicator of quality, but that have been incorporated into an intelligent, algorithm that can accurately predict or determine the likely quality of the underlying work product without first analyzing the underlying work product. The system and method are able to automatically determine an evaluation metric that is assigned to the work product. The evaluation metric can then be used to determine the appropriate amount of human or other review required for a particular task. The evaluation metric may be calculated by accessing and evaluating a plurality of transaction categories related, but not limited to, worker characteristics, document characteristics and processing characteristics. Additionally, the evaluation metric may be used to determine compensation of the processing worker and whether a promotion or demotion, for example, is necessary. The system is also capable of balancing individual workloads based upon the evaluation metric, thus inhibiting low quality workers, such as spammers, from consuming a large portion of the available tasks.

In accordance with one aspect of the invention, a system for automatically assigning an evaluation metric to work performed by a processing worker is disclosed. The system includes a non-transitory, computer-readable storage medium having stored thereon a plurality of input documents configured to be processed by a processing worker. The system further includes a communications connection configured to provide access to the non-transitory, computer-readable storage medium by the processing worker to generate a plurality of processed documents. A processor is configured to access the non-transitory, computer-readable storage medium to receive the plurality of input documents or processed documents. The processor then accesses a plurality of transaction categories related to worker characteristics, document characteristics or processing characteristics and evaluates the plurality of input documents or the processed documents using the transaction categories. An evaluation metric is calculated related to the processing worker and the plurality of processed documents based on the transaction categories and an amount of human review to be performed on the plurality of processed documents is determined based on the evaluation metric.

In accordance with another aspect of the invention, a method for automatically assigning an evaluation metric to work performed by a processing worker is disclosed. The method includes providing a plurality of input documents configured to be processed by a processing worker and generating a plurality of processed documents from the plurality of input documents. A plurality of transaction categories are defined related to worker characteristics, document characteristics or processing characteristics. The plurality of input documents and processed documents are evaluated using the transaction categories and an evaluation metric is calculated related to the processing worker and the plurality of processed documents based on the transaction categories. An amount of human review to be performed on the plurality of processed documents is determined based on the evaluation metric.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a schematic view of an environment in which an embodiment of the invention may operate.

FIG. 2 shows a representation of an example image input document.

FIG. 3 is a flow chart setting forth the steps of processes for assigning an evaluating metric to work performed by a processing worker.

FIG. 4 is a continuation of the flow chart of FIG. 3.

FIG. 5 shows a representation of an example task life cycle through different levels of hierarchy of a processing worker.

### DETAILED DESCRIPTION OF THE INVENTION

This description primarily discusses illustrative embodiments as being implemented in conjunction with restaurant menus. It should be noted, however, that discussion of restaurant menus simply is one example of many different types of unstructured data items that apply to illustrative embodiments. For example, various embodiments may apply to unstructured listings from department stores, salons, health clubs, supermarkets, banks, movie theaters, ticket agencies, pharmacies, taxis, and service providers, among other things. Accordingly, discussion of restaurant menus is not intended to limit various embodiments of the invention.

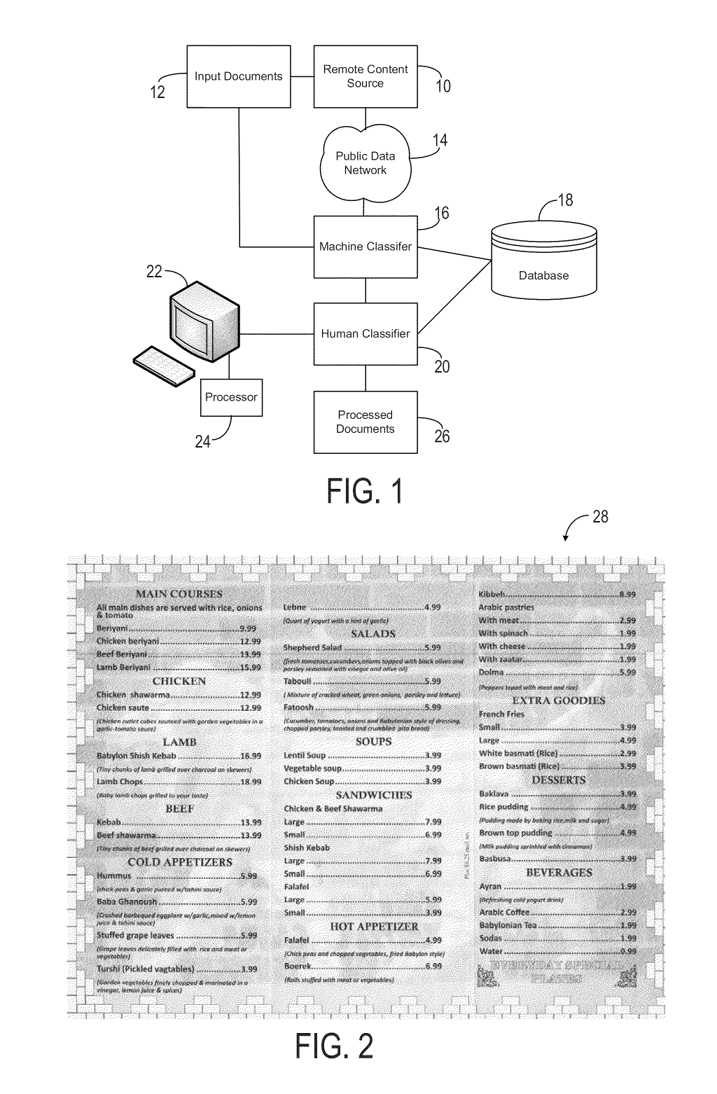

Referring now to FIG. 1 a schematic view of an environment in which the invention may operate is shown. The environment includes one or more remote content sources 10, such as a standard web server or a non-transitory, computer-readable storage medium on which are input documents 12 from which features are to be extracted. The remote content sources 10 are connected, via a data communication network 14 such as the Internet, to a machine classifier 16 in accordance with an embodiment of the invention. As described in more detail below, the machine classifier 16 may extract relevant features from an unstructured document 28 (e.g., PDF, Flash, HTML), as shown in FIG. 2, and that can be later presented as input documents 12. It is noted that the machine classification may take many forms. In some instances, the machine classification may include optical character recognition or other processing. In others, the machine classification may include little or no analysis or changes to an image or other raw data source.

The relevant features may be stored in a database 18. Optionally, the extracted features may be presented to a human classifier 20, such as an processing worker sitting at a remote computer terminal 22 having attached thereto a processor 24. The human classifier 20 may evaluate the accuracy of the machine classification and make corrections to features that were misclassified by the machine classifier 16, thus producing processed documents 26.

In various embodiments, the remote content sources 10 may be any conventional computing resources accessible over a public network. The network 14 may be the Internet, or it may be any other data communications network that permits access to the remote content sources 10. The machine classifiers 16 may be implemented as discussed below. The database 18 may be any database or data storage system known in the art that operates according to the limitations and descriptions discussed herein. A human classifier 20 is any individual or collection of individuals (i.e., crowd workers or processing workers) that operates to correct misclassified features extracted from the input documents 12.

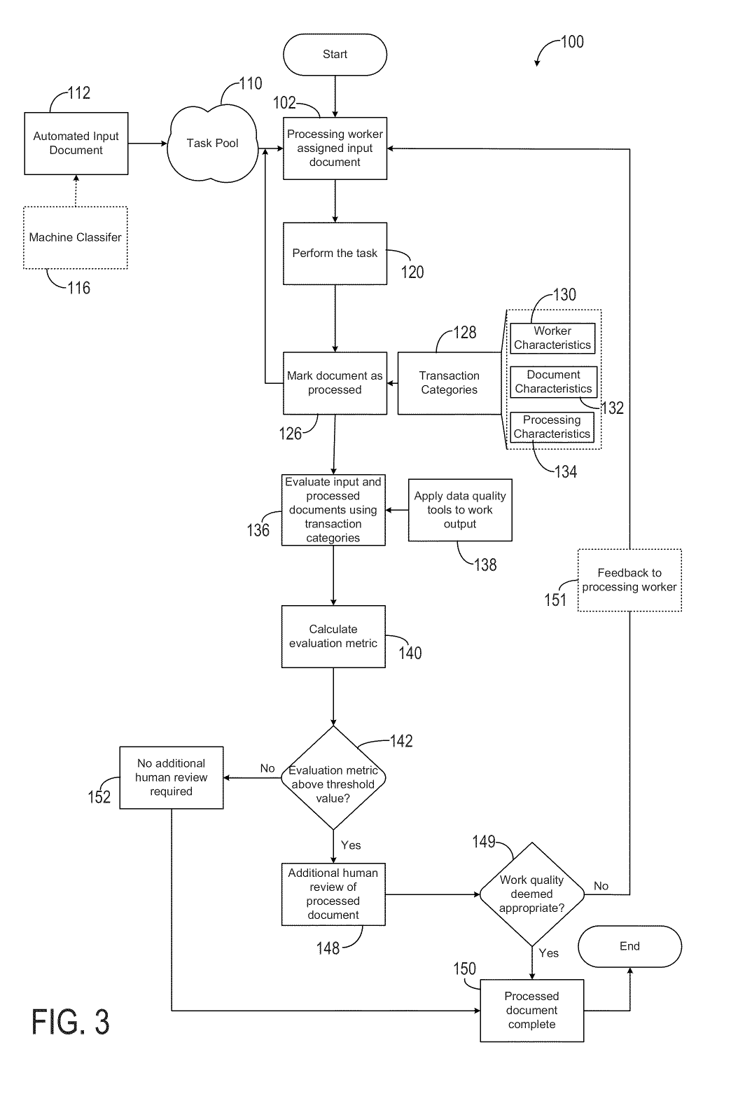

Referring now to FIG. 3, a flow chart setting forth exemplary steps 100 for automatically assigning an evaluation metric to work performed by the processing worker is provided. To start the process, the processing worker 20, as shown in FIG. 1, may be assigned an input document at process block 102 from the task pool 110. However, prior to the processing worker receiving an input document, at process block 116, the machine classifier may extract relevant features of an unstructured document and store them in the database 18 of FIG. 1. If so, the input document 112, such as a restaurant menu, is then compiled using the relevant features that were previously extracted from the unstructured document referenced, such as by a URL, for example. The input documents generated at process block 112 are then put into the task pool 110 to be assigned to a processing worker at process block 102.

The machine classifier shown at processing block 116 may be implemented in any effective physical manner. Thus, the processes described above may be executed on a single computer, or on a plurality of computers in a cloud-based arrangement, for example. A single network connection may service multiple classifiers, memories, content classifiers, context classifiers, or visual style classifiers. The numbers and locations of the classifiers may be determined statically based on application, or dynamically based on real-time demand. Moreover, there may be one database 18, as shown in FIG. 1, or a plurality of distributed databases for storing relevant features. The remote content source 10 may be a single memory or a plurality of memories distributed throughout the data communication network 14. A plurality of computer terminals 22 may be paired to each other for human reclassification.

Thus, the machine classifier at process block 116 may extract useful textual information from what may be otherwise unstructured documents, such as images, and classify the text for subsequent processing. Textual classes may be chosen on an application-specific basis. If the application is processing restaurant menus, as shown in FIG. 2, then the textual classes may include, for example: Menu Name, Section, Subsection, Section Text, Item Name, Item Description, Item Price, Item Options, and Notes. In the particular example of FIG. 2, Sections include “Main Courses”, “Chicken”, “Lamb”, “Beef”, “Cold Appetizers”, “Salads”, “Soups”, “Sandwiches”, “Hot Appetizer”, “Extra Goodies”, “Desserts”, and “Beverages”. Item Names include “Beriyani”, “Chichen Shawarma”, and “Lamb Chop”, for example. One Item Description is “Chicken cutlet cubes sautéed with garden vegetables in a garlic-tomato sauce”. Item Prices include, but are not limited to, “9.99”, “12.99”, and “13.99”. Item Options may include how well a meat dish is cooked (not shown in FIG. 2). Notes include “All main dishes are served with rice, onions & tomato”. As may be understood, the textual classes are application-specific, and even within a given application such as menu feature extraction, the textual classes themselves may vary from one input document to the next.

However, the machine classifier shown at process block 116 may not be entirely accurate. For example, when the input documents are in the form of HTML pages and other markup language input documents, the machine classifier parses the markup language to extract the relevant features. For other cases, such as image sources, the machine classifier may perform column detection, for example, and optionally perspective correction, super-sampling, and optical character recognition (OCR). For example, in a restaurant menu context, input documents of whatever source format are translated into a structured price-list schema and stored as an intermediate representation (IR) that captures both textual style and content. Such an IR may be, for example, HTML+CSS or other easily manipulable data storage format.

Due to the inherent inaccuracy of machine classifiers, processing workers are often needed to correct misclassified features extracted from the input documents at process block 112. Returning back to FIG. 3, once the processing worker is assigned an input document at process block 102, they may perform the necessary task at process block 120. The task performed at process block 120 may include, for example, editing and structuring price and/or service lists, and editing business listings information, such as a business address, phone number, email address or business description, for venues in the database. When the processing worker has completed the task at process block 120, he/she may mark the document as processed at process block 126, thereby creating a processed document. The processing worker may then return to process block 102 to request another input document.

While the input document goes through the cycle of being assigned to a processing worker, corrected and reviewed by the processing worker, and marked as a processed document, the processor 24 of FIG. 1 may be configured to track a variety of transaction categories associated with the document at process block 128. One example transaction category may include worker characteristics as shown at process block 130. Such worker characteristics may include, but are not limited to, a worker hierarchy role, an author of the processed documents, an age of the author of the processed documents, a worker's past task quality, a worker's past menu categories, a worker's past spelling errors, or a location where the processed documents were processed. Another transaction category may include document characteristics as shown at process block 132. Such document characteristics may include, for example, a number of items (e.g., Menu Name, Section, Subsection, Section Text, Item Name, Item Description, Item Price, Item Options, Notes, business address, phone number, email address, business description, etc.) in the input documents and the processed documents, an average number of items per section in the input document and the processed documents, a source of the input documents (e.g., the URL), a number of price options per item in the input documents and the processed documents, or a type of restaurant reflected in the input and processed documents. Lastly, processing characteristics may be another example of a transaction category, as shown at process block 134. Processing characteristics may include, but are not limited to, a time the processed documents were processed, a date the processed documents were processed, a day of the week the processed documents were processed, and an amount of time the processing worker spent on processing the processed documents.

The above described data acquired through the transaction categories may be stored in the database 18 of FIG. 1. Once the processed document is marked as processed at process block 126, the processor may evaluate, using an algorithm for example, the input and processed documents at process block 136. The input and processed documents may be evaluated at process block 136 using the data acquired through the transaction categories at process block 128. In addition to the data acquired through the transaction categories, data quality tools may be applied at process block 138 to evaluate the input and processed documents. The data quality tools will be described later in further detail.

Once the input and processed documents are evaluated at process block 136 using the data acquired through the transaction categories at process block 128, an evaluation metric is calculated at process block 140. The evaluation metric 140 may be specific to the processing worker who converted the input document to the processed document and/or may be associated with the processed document itself. The evaluation metric may be a numeric value, for example, indicative of the quality of the processing worker, as well as whether the processed document requires additional review by another processing worker or manager, for example. In one non-limiting example, the evaluation metric may be calculated as a prediction of how much, as a percentage, an input document will be changed by the processing worker. The calculated evaluation metric may then be compared to a predetermined threshold valve at process block 142 to determine whether additional review is needed and whether to increase or decrease the work load of the processing worker.

The evaluation metric may be calculated using the algorithm programmed in the processor 24 of FIG. 1. The algorithm may be a supervised boosted random forest regression model, for example, that can predict errors as well as how much of an input document will be changed by a processing worker. The algorithm may include all, or a portion of, the data acquired from the transaction categories at process block 128. For example, the algorithm may determine the fraction of lines in a processed document that are incorrect (e.g., 1.0 represents a completely incorrect task, and 0.0 represents a perfect task). The algorithm may then estimate this value for tasks that have already been reviewed by taking a difference between the output of the original processing worker and the output of the reviewing worker, and calculate the percentage of lines that were changed. However, to predict task quality of un-reviewed tasks, the algorithm may incorporate a supervised boosted random forest regression model to use a sample of several hundred thousand previously reviewed tasks, for example.

Returning now to FIG. 3, an evaluation metric above the predetermined threshold may be given if the processing characteristics 134 indicates that the processing worker completed the processed document at 2:00 AM on a Saturday night, for example, and the amount of time spent processing the document was inadequate given the number of items (e.g., number of “Main Courses”) in the processed document. As another example, an evaluation metric above the predetermined threshold may be given if the document characteristics indicate a small number of items in the processed documents and the processing characteristics indicate an inappropriate amount of time (e.g., too much time) was spent by the processing worker to process the document. Additionally, an evaluation metric above the predetermined threshold may be given if, for example, the worker characteristics 130 indicate an inappropriate age (e.g., under sixteen years old). Other combinations of processing, document and worker characteristics can be evaluated individually or together to calculate the evaluation metric and determine whether the evaluation metric is above or below the predetermined threshold value at process block 142.

If the evaluation metric related to the processing worker is above the predetermined threshold at process block 142, as described in the examples above, the processor may be configured to require additional review of the processed document at process block 148. The processed document may be assigned to another processing worker, to ensure the processed document meets certain quality requirements defined by the system. At process block 149, if the processor determines the work quality is appropriate, for example, and the amount of human review is complete, the processed document is labeled complete at process block 150. However, if the processor determines the work quality is not appropriate and the amount of human review is not complete at process block 149, the processed document may be sent back to the worker and assigned as an input document at process block 102. Optionally, at process block 151, immediate feedback, including corrections or revisions, for example, may be given to the processing worker if the human reviewer at process block 148 decides to send the processed document with feedback to the original reviewer as an input document at process block 102. Once the processing worker completes the task at process block 120 of making the necessary correction or revisions provided by the human reviewer, the document continues through the same steps 100 as previously outlined. As a result, decreasing the processing worker's workload serves as a quality control and cost savings means, such that the processing worker will receive fewer input documents to process at process block 102. This leads to fewer low quality processed documents being produced overall and less review required by additional processing workers.

However, if the evaluation metric is below the predefined threshold value at process block 142, the processor may be configured to require no additional review of the processed document. As previously described, the algorithm may include all, or a portion of, the data acquired from the transaction categories at process block 128. For example, an evaluation metric below the predetermined threshold may be given if the processing characteristics 134 indicate that the processing worker completed the processed document at 2:00 PM on a Tuesday afternoon, for example, and the amount of time spent processing the document was adequate given the number of items in the processed document. As another example, an evaluation metric below the predetermined threshold may be given if the document characteristics indicate a small number of items in the processed documents and the processing characteristics indicate an appropriate amount of time was spent by the processing worker to process the document. Additionally, an evaluation metric below the predetermined threshold may be given if, for example, the worker characteristics 130 indicate an appropriate age (e.g., over sixteen years old). Other combinations of processing, document and worker characteristics can be evaluated individually or together to calculate the evaluation metric and determine whether the evaluation metric is above or below the predetermined threshold value at process block 142.

If the evaluation metric related to the processing worker is below the predetermined threshold at process block 142, as described in the examples above, the processor may be configured to not assign another processing worker additional review of the processed document, at process block 152, since the processed document meets the quality requirements defined by the system. The processed document may then be marked complete at process block 150. Additionally, the processor determines whether to review the processed documents, and if additional review is needed, the processor can determine how much additional review is required.

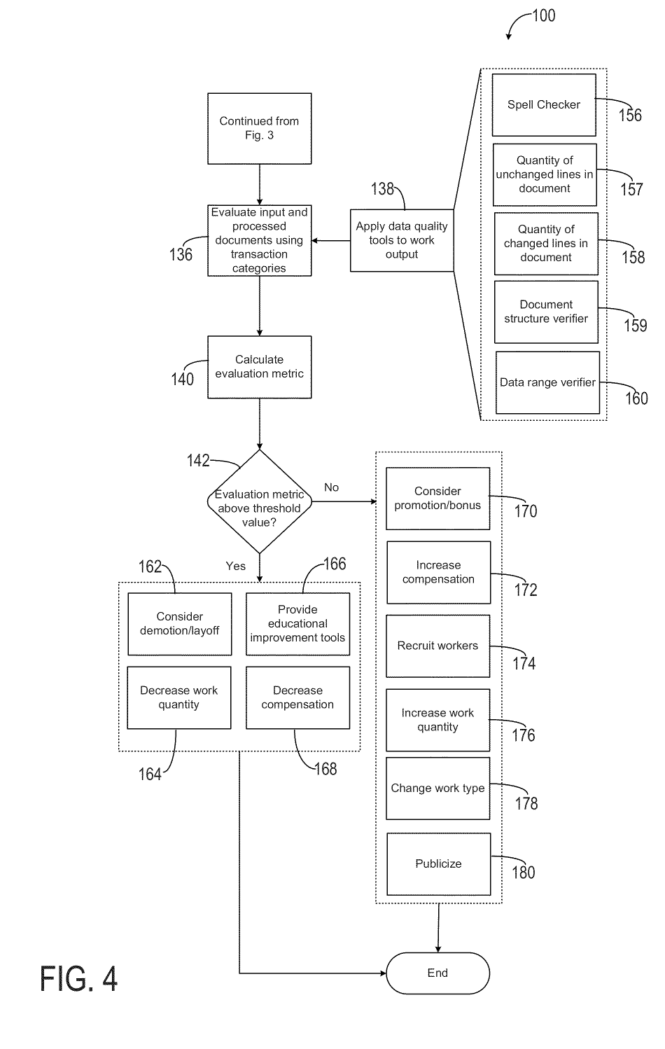

Referring now to FIG. 4, the flow chart is continued from FIG. 3 setting forth additional exemplary steps 100 for automatically assigning an evaluation metric to work performed by the processing worker. Returning to process block 136, as previously described, once the processed document is marked as processed at process block 126, the processor may evaluate, using the algorithm for example, the input and processed documents. The input and processed documents may be evaluated at process block 136 using the data acquired through the transaction categories, as previously described, as well as the data quality tools applied at process block 138. The data quality tools may include, but are not limited to, spell checking applications 156 and applications configured to calculate the quantity of unchanged and changed lines in the processed document compared to the input document, as shown at process blocks 157 and 158, respectively. Other data quality tools may include document structure verifiers, as shown at process block 159, and data range verifiers at process block 160. The document structure verifiers at process block 159 may include checking whether the items within the processed document include the appropriate corresponding data. For example, the document structure verifier may determine whether all the menu item names in a processed document include a corresponding price. The data range verifier at process block 160 may determine whether a price associated with a menu item is reasonable or accurate. For example, the data range verifier may flag a menu item, such as “Hummus” as shown on the menu 28 of FIG. 2, having a corresponding price of $599.00 as being inaccurate.

Once the input and processed documents are evaluated at process block 136 using the data quality tools at process block 138, and, optionally, the data acquired through the transaction categories, an evaluation metric is calculated at process block 140. The evaluation metric 140 may be specific to the processing worker who converted the input document to the processed document. The evaluation metric may be a numeric value, for example, indicative of the quality of the processing worker, as well as the processing worker's likelihood of receiving a promotion or other incentivizing reward, for example. Thus, the evaluation metric may also be used for automating promotions, demotions and incentives for processing workers.

At process block 142, the calculated evaluation metric may then be compared to a predetermined threshold valve to determine whether the processing worker is qualified for a promotion or demotion, for example, based on an aggregate of the processing worker's past tasks. The evaluation metric may be calculated using the algorithm programmed in the processor 24 of FIG. 1. The algorithm may include all, or a portion of, the data acquired from the data quality tool at process block 138. For example, an evaluation metric above the predetermined threshold may be given to the processing worker if the spell checker application 156 uncovers an unacceptable number of spelling errors in the aggregate number of processed documents. For example, the processor may be programmed to relate the total number of spelling errors to the total number of items in the document as a percentage, for example. If the percentage is above a predetermined value (i.e., a high percentage of spelling errors), a higher evaluation metric may be assigned to that processing worker. Where as if the percentage is below a predetermined value (i.e., a low percentage of spelling errors), a lower evaluation metric may be assigned.

As another example, an evaluation metric above the predetermined threshold may be given if the line counter applications 157 and 158 count too few unchanged lines or too many changed lines relative to the number of items in the input and processed documents, for example. Too few unchanged lines may indicate the processing worker did not spend the appropriate amount of time processing the document, whereas too many changed lines may indicate the processing worker spent too much time processing the document

If the evaluation metric related to the processing worker is above the predetermined threshold at process block 142, as described in the examples above, the processor may be configured to demote or layoff the processing worker at process block 162, for example. Additionally, or alternatively, the processor may be configured to decrease the work quantity at process block 164 by decreasing the quantity of input documents assigned to that processing worker, or provide educational improvement tools 166 to help the processing worker become more efficient, for example, at processing input documents. Another option may be to decrease the processing worker's compensation at process block 168 if the evaluation metric related to the processing worker is above the predetermined threshold at process block 142. The severity of the action taken with the processing worker when the evaluation metric is above the predetermined threshold value at process block 142 may be determined over a period of time. For example, if the processing worker is new to processing input documents and the line counter application reveals too few changed lines in the processed document, the processor may provide educational improvement tools as indicated at process block 166, rather than decreasing the processing worker's compensation as indicated at process block 168. If, however, the processing worker has been processing documents for a longer period of time (e.g., several years or several months), the action taken with the processing worker when the evaluation metric is above the predetermined threshold value at process block 142 may be more severe. For example, if the processing worker has been processing input documents for several years and the spell checker application 156 continuously indicates an inappropriate quantity of spelling errors in the processed documents, the processor may suggest a decrease in compensation, as indicated at process block 168, or a demotion, at process block 162.

However, an evaluation metric below the predetermined threshold value may be given to the processing worker at process block 142 if the spell checker application 156 uncovers an acceptable number of spelling errors in the processed document. As another example, an evaluation metric below the predetermined threshold may be given if the line counter applications 157 and 158 count the appropriate number of unchanged lines or changed lines in the document relative to the number of items in the input and processed documents, for example. The appropriate number of unchanged lines and changed lines may indicate the processing worker spent the appropriate amount of time processing the document.

If the evaluation metric related to the processing worker is below the predetermined threshold at process block 142, as described in the examples above, the processor may be configured to suggest the processing worker be promoted or given a monetary bonus, for example, at process block 170. Additionally, or alternatively, the processor may be configured to increase the processing worker's compensation at process block 172 or be given the opportunity to recruit their own processing workers at process block 174. At process block 176, the processor may be configured to increase the processing worker's work quantity, by increasing the quantity of input documents assigned to that processing worker. Thus, increasing the processing worker's workload serves as a quality control and cost savings means, such that the processing worker will receive additional input documents to process at process block 102 of FIG. 3. This leads to more high quality processed documents being produced overall and little to no review required by additional processing workers. Thus, the evaluation metric not only helps balance the workload of processing workers in real time, but may reduce costs by not having the same input and processed documents reviewed several times. In addition, the processor may also be configured to change the type of work or documents assigned to the processing worker at process block 178 to continue to incentivize the processing worker. Publically announcing a particular processing worker's evaluation metric at process block 180 may be another way to incentivize and motivate processing workers.

In an alternative embodiment, the processes described with respect to FIGS. 3 and 4 may be implemented into a service level agreement (SLA), for example, and provided as a service to crowd-sourcing management entities. Crowd-sourcing management entities may then benefit from the quality control and cost savings previously described with respect to processing workers. The service may provide crowd-sourcing management entities, both in terms of an accuracy and correctness statistical metric, the cost tradeoff that stems from the service. For example, if the crowd-sourcing management entity requires a statistical 98% accuracy with a given level of confidence on tasks, the tasks can either go through two levels of review or a single level of review through a processing worker with quality history (i.e., evaluation metric) above a certain level. However, if the crowd-sourcing management entity only requires a statistical 85% accuracy, for example, the given tasks may be reviewed by a processing worker with a quality history at a different level. Thus, the service provided to crowd-sourcing management entities may include a minimal cost function based on an accuracy score for a given type of task. This cost function may then be factored into part of the SLA. Additionally, the service provided to crowd-sourcing management entities may allow the cost per task to be adjusted based on the importance of the source data. For example, accuracy, and thus cost, may be lower for a task that is for venue that had poor business reviews or ratings, for example, and is thus not frequently seen by consumers.

In yet another alternative embodiment, processing workers may be assigned different positions within a hierarchy. For example, an entry-level position, such as a Data Entry Specialist (DES), might require the processing worker, for example, to look at price lists, service lists, or business listing from a merchant and type it up or correct the content in it. The DES may process incoming tasks and process them to completion. Thus, the entry-level workers may be compensated for the amount of work they do on each task. The work an entry-level worker did may be a function of the difference between the content the machine classifier extracted from the raw price list, service list or business listing, and the final processed document that all of the processing workers collectively produced. For example, as previously described, the line counter applications 157 and 158 of FIG. 4 may count the number of lines that are different between the automated tools' output and the finished product, and calculate the entry-level workers' pay to be proportional to this difference.

Additionally, an entry-level worker's work may be examined by a more experienced processing worker, such as a reviewer. The reviewer generally has to do less work on structuring or extracting data. Instead, the reviewer looks at the tasks completed by the DES, makes small corrections, provides feedback, and sends back any major errors to the DES with comments explaining how to fix the mistakes, and pointers to educational documentation, for example, so that the DES can learn more. After several rounds of back-and-forth review, a reviewer may approve the task. Reviewers are paid for their time rather than per task, so that they spend as much time as is necessary on each task. Additionally, managers may server as a cross-cutting role by arbitrating disagreements and holistically training workers.

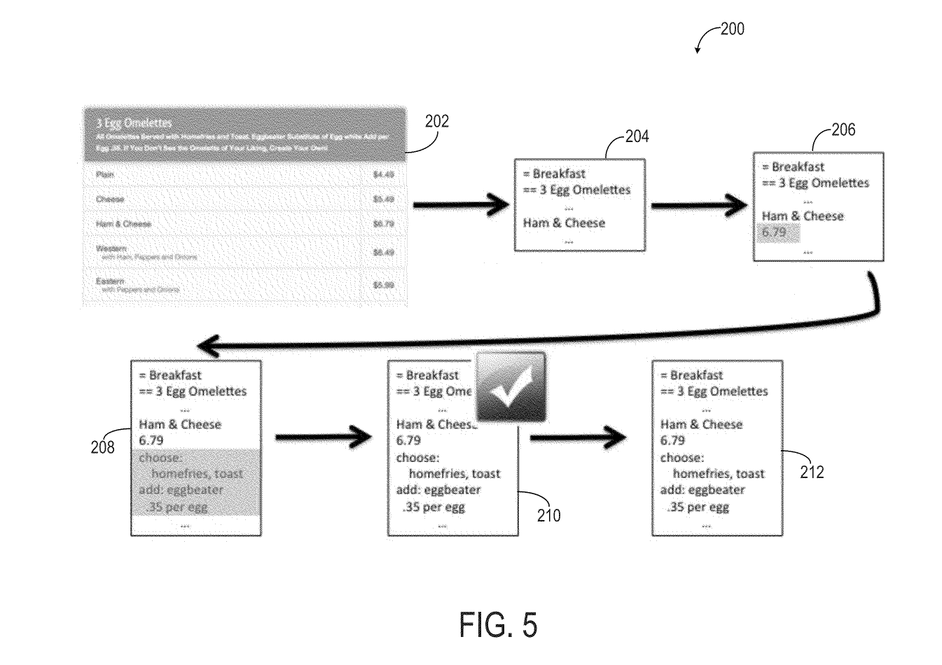

In order to vet the work of reviewers, reviewers may also be assigned to review other reviewers. In these scenarios, the second reviewer performs the same tasks as the first reviewer, and the first reviewer performs the same tasks as the entry-level worker. An exemplary task life cycle 200 through the different levels of worker hierarchy is shown in FIG. 5. First, at step 202 a menu, for example, is found online and passed through machine learning extraction at step 204 to discover menu sections, subsections, and items, for example. At step 206, a DES may attempt to fill in data, such as a price, that the algorithms miss. Reviewers may then correct mistakes at step 208 that were made by the previous workers (e.g., DES or lower-level reviewer) at step 206 before approving the task at step 210, for example. At step 212, the final output may be displayed having a wikitext-like syntax, for example.

The above described hierarchical review process can serve two purposes. First, it allows the system to vet any task's quality with trusted reviewers, while training entry-level workers in the process. Thus, due to the iterative nature of the hierarchical review process, workers benefit from the experience of previous workers who have completed the task. Second, it allows the system to collect an aggregate measure of workers' overall quality. For example, on any task, the fraction of the lines that remain untouched after review indicates a sense of the quality of the work that a reviewed worker did on that task. In aggregate, a statistic (e.g., mean, median, mode, or percentile) may be calculated across all of the task quality metrics a worker has recently performed to determine that worker's recent overall work quality.

While the number of hierarchical reviews on a task can be unbounded, in practice it is not. When a worker has done a substantial amount of work and the system is confident in the overall measure of their work quality, the likelihood that reviewing their work output will result in higher quality work may be estimated. Given a monetary budget, for example, across several tasks, the system can determine which task a reviewer would most likely improve based on their work quality and the work quality of the workers that already contributed to the task. Alternatively, a desired amount of money may be spent on each task in expectation by periodically determining the fraction of tasks that should be reviewed for each worker based on their overall quality.

In addition to how likely a worker is to be corrected when reviewed, other matters may be taken into account, like how quickly a worker finishes a task, and how well a set of automated data quality tools rate the task the worker just performed. An example of an automated data quality tool, as previously described, is a spellchecker that determines how many spelling errors a worker submits a task with. A combination of all of the curated and automated quality scores, as well as the worker's speed, allow the system to rank the workers. Based on this ranking, the system can automatically decide which workers are worthy of promotion, demotion, or layoff, for example. By promoting the highest quality workers, in turn, may improve the odds that reviewers will catch lingering errors.

In addition to promotion, demotion, or layoff, processing workers are also incentivized to improve their work. These incentives may have several forms, including, but not limited to, monetary incentives where workers that rank higher can be paid more or given bonuses, or nonmonetary incentives where the workers' rankings can be publicized. Educational incentives may also be provided where processing workers may be provided with educational opportunities and tools depending on the kinds of mistakes made. Because reviewers classify workers' mistakes, customized feedback, documentation, or even purchase items such as books on the workers' behalf may be provided. In addition, processing workers that rank higher can be shown more interesting tasks and may have access to more tasks or more hourly work per week so that they can earn more money. Further, processing workers that rank higher may be invited to recruit and train their own entry-level workers, and share in those workers' earnings.

While the hierarchical review process can improve work quality and facilitate worker training, there are other roles that help improve the quality and efficiency of processing workers. For example, the best workers may be promoted into these roles, or they may be hired for these roles specifically. These nonhierarchical roles include, but are not limited to management, training and documentation. Management roles may include day-to-day operational tasks such as making announcements or preparing tasks to be processed can be provided to managerial crowd workers. Training roles may include looking at several of a worker's reviewed tasks, identify systemic issues, and make recommendations or provide documentation to the worker so that they can improve. While documentation roles may include creating additional documentation for other workers to consume as new task types and learning opportunities arise.

The present invention has been described in terms of one or more preferred embodiments, and it should be appreciated that many equivalents, alternatives, variations, and modifications, aside from those expressly stated, are possible and within the scope of the invention.

1. A system for automatically assigning an evaluation metric to work performed by a processing worker, the system comprising:
a non-transitory, computer-readable storage medium having stored thereon a plurality of input documents configured to be processed by a processing worker;
a communications connection configured to provide access to the non-transitory, computer-readable storage medium by the processing worker to generate a plurality of processed documents;
a processor configured to carry out steps of:
i) accessing the non-transitory, computer-readable storage medium to receive at least one of the plurality of input documents and processed documents;
ii) accessing a plurality of transaction categories related to at least one of worker characteristics, document characteristics and processing characteristics;
ii) evaluating the at least one of the plurality of input documents and processed documents using the transaction categories;
iii) calculating an evaluation metric related to the processing worker and the plurality of processed documents based on the transaction categories; and
iv) determining, based on the evaluation metric, an amount of human review to be performed on the plurality processed documents.

2. The system of claim 1, wherein the processor is further configured to assign at least one of a compensation value, a promotion, a demotion, a layoff, a monetary bonus, an increased workload, a decreased workload, a receipt of educational improvement tools, and a change in work type to the processing worker using the evaluation metric.

3. The system of claim 1, wherein the transaction categories include at least one of a time the plurality of processed documents were processed, a date the plurality of processed documents were processed, a day of the week the plurality of processed documents were processed, a number of items in the plurality of processed documents, an average number of items per section in the plurality of processed documents, a source of the plurality of processed documents, a number of price options per item in the plurality of processed documents, a type of restaurant reflected in the plurality of input documents, a type of business reflected in the plurality of input documents, a worker hierarchy role, an author of the plurality of processed documents, a location where the plurality of processed documents were processed, an age of the author of the plurality of processed documents, a worker's past quality of the plurality of processed documents, a worker's past menu categories, a worker's past spelling errors and an amount of time the processing worker spent on processing the plurality of processed documents.

4. The system of claim 1, wherein the processor is further configured to balance a workload of the processing worker based on the evaluation metric being at least one of above and below a predetermined threshold value.

5. The system of claim 4, wherein when the evaluation metric is above the predetermined threshold value, the processor assigns the processing worker a smaller quantity of the plurality of input documents to be processed.

6. The system of claim 4, wherein when the evaluation metric is below the predetermined threshold value, the processor at least one of assigns the processing worker a larger quantity of the plurality of input documents to be processed and assigns the processing worker an authority level to invite other processing workers to be managed by the processing worker.

7. The system of claim 1, wherein the plurality of input documents include menus from a plurality of restaurants.

8. The system of claim 1, wherein the plurality of input documents include at least one of a list of offerings and a list of prices from a plurality of business types.

9. The system of claim 8, wherein the plurality of business types include at least one of restaurants, salons, department stores, health clubs, supermarkets, banks, movie theaters, ticket agencies, pharmacies, taxis, and service providers.

10. The system of claim 1, wherein when the evaluation metric is above a predetermined threshold value, the amount of human review to be performed on the plurality of processed documents is higher compared to when the evaluation metric is below a predetermined threshold value.

11. The system of claim 1, wherein the processing workers are located at a remote location.

12. The system of claim 1, wherein the processor is configured to execute data quality tools to compare at least one of the plurality of input documents to at least one of the plurality of processed documents.

13. The system of claim 12, wherein the data quality tools include at least one of a spell checker, a document structure verifier, a data range verifier, and a tool configured to quantify at least one of a number of unchanged lines and a number of lines that are different within at least one of the plurality of input documents and the plurality of processed documents.

14. A method for automatically assigning an evaluation metric to work performed by a processing worker, the steps of the method comprising:
providing a plurality of input documents configured to be processed by a processing worker;
generating a plurality of processed documents from the plurality of input documents;
defining a plurality of transaction categories related to at least one of worker characteristics, document characteristics and processing characteristics;
evaluating the at least one of the plurality of input documents and processed documents using the transaction categories;
calculating an evaluation metric related to the processing worker and the plurality of processed documents based on the transaction categories; and
determining, based on the evaluation metric, an amount of human review to be performed on the plurality of processed documents.

15. The method of claim 14, further comprising the step of assigning at least one of a compensation value, a promotion, a demotion, a layoff, a monetary bonus, an increased workload, a decreased workload, a receipt of educational improvement tools, and a change in work type to the processing worker using the evaluation metric.

16. The method of claim 14, further comprising the step of determining, using the transaction categories, at least one of a time the plurality of processed documents were processed, a date the plurality of processed documents were processed, a day of the week the plurality of processed documents were processed, a number of items in the plurality of processed documents, an average number of items per section in the plurality of processed documents, a source of the plurality of processed documents, a number of price options per item in the plurality of processed documents, a type of restaurant reflected in the plurality of input documents, a type of business reflected in the plurality of input documents, a worker hierarchy role, an author of the plurality of processed documents, a location where the plurality of processed documents were processed, an age of the author of the plurality of processed documents, a worker's past quality of the plurality of processed documents, a worker's past menu categories, a worker's past spelling errors and an amount of time the processing worker spent on processing the plurality of processed documents.

17. The method of claim 14, further comprising the step of balancing a workload of the processing worker based on the evaluation metric being at least one of above and below a predetermined threshold value.

18. The method of claim 17, further comprising the step of assigning the processing worker a smaller quantity of the plurality of input documents to be processed when the evaluation metric is above the predetermined threshold value.

19. The method of claim 17, further comprising the step of at least one of assigning the processing worker a larger quantity of the plurality of input documents to be processed and assigning the processing worker an authority level to invite other processing workers to be managed by the processing worker when the evaluation metric is below the predetermined threshold value.

20. The method of claim 14, wherein providing the plurality of input documents includes providing menus from a plurality of restaurants to the processing worker.

21. The method of claim 14, wherein providing the plurality of input documents includes providing at least one of a list of offerings and a list of prices from a plurality of business types.

22. The method of claim 21, wherein the plurality of business types include at least one of restaurants, salons, department stores, health clubs, supermarkets, banks, movie theaters, ticket agencies, pharmacies, taxis, and service providers.

23. The method of claim 14, further comprising the step of assigning a higher amount of human review to be performed on the plurality of processed documents when the evaluation metric is above a predetermined threshold, and assigning a lower amount of human review to be performed on the plurality of processed documents when the evaluation metric is below the predetermined threshold.

24. The method of claim 14, wherein processing the plurality of input documents occurs at a remote location.

25. The method of claim 14, further comprising the step of executing data quality tools to compare at least one of the plurality of input documents to at least one of the plurality of processed documents.

26. The method of claim 25, wherein the data quality tools include at least one of a spell checker, a document structure verifier, a data range verifier, and a tool configured to quantify at least one of a number of unchanged lines and a number of lines that are different within at least one of the plurality of input documents and the plurality of processed documents.
